(19) United States
(12) Patent Application Publication
(10) Pub. No.: US 2018/0103085 A1
(43) Pub. Date: Apr. 12, 2018

(54) Data Transfer in a Communication System

(71) Applicant: Microsoft Technology Licensing, LLC, Redmond, WA (US)

(72) Inventors: Bin Fang, Beijing (CN); Peter Feng Zeng, Beijing (CN); Min Wan, Beijing (CN); Rakesh Midha, Hyderabad (IN); Guang Yang, Bellevue, WA (US); Congrui Huang, Beijing (CN); Shashank Agarwal, Hyderabad (IN); Soubhagya Ranjan Nayak, Hyderabad (IN)

(73) Assignee: Microsoft Technology Licensing, LLC, Redmond, WA (US)

(21) Appl. No.: 15/396,718

(22) Filed: Jan. 2, 2017

(30) Foreign Application Priority Data
Oct. 6, 2016 (IN) 201641034331

(51) Int. Cl. H04L 29/08; H04L 12/26

(52) U.S. Cl. CPC H04L 67/06; H04L 67/141; H04L 67/42; H04L 43/10; H04L 43/0882

(57) ABSTRACT

A server, user terminal, system, method and computer-program product for performing a data transfer to upload a data file from the user terminal to the server or download a data file from the server to the user terminal, via a connection over a network. The method comprises evaluating a size of the data file to be uploaded or downloaded, determining a measure of a current workload of the server, and estimating a bandwidth of at least part of the connection. A time-out window is derived during which the transfer of the data file is allowed to be performed, wherein the deriving of the time out window is performed based the data file size, server workload and bandwidth. The data transfer is enabled during the time-out window, but timed out when the time-out window expires.

### RELATED APPLICATIONS

This application claims priority under 35 USC 119 or 365 to India Application No. 201641034331 filed Oct. 6, 2016, the disclosure of which is hereby incorporated by reference in its entirety.

### BACKGROUND

Various technologies exist which enable users to conduct communications over a computer network, such as the Internet. These technologies include instant messaging (IM), voice calls such as voice-over Internet Protocol (VoIP) calls, video calls, sharing data files such as still images (picture messaging), video clips (video messaging), applications and programs, screen-sharing streams, remote slide presentations, and virtual whiteboards, and sharing one's geographic location. A user may wish to share a data file directly with a remote user during an instant messaging session, or alternatively said user may opt to upload and store the data file at said server to be consumed at a later time.

These communications are conventionally performed from a user terminal (e.g. a desktop computer) through a fixed home network connection (e.g. a PSTN network or a wireless access point) to connect to the Internet. More recently, the advance in network technologies enables the use of personal mobile device to conduct such communications through a mobile network (e.g. 2G, 3G, LTE or 4G mobile network). Nevertheless, whilst these provide adequate bandwidth for less demanding tasks such as instant messaging and voice calls, some mobile networks are less suitable of transferring large data files, e.g. high resolution images, videos, and programme files. In some cases the uploading or downloading operation consumes significant network resources, and in some cases affects other communication instances. In order to free up the network, an established connection may be disconnected after a predetermined period of time before the transfer is fully completed, known as time out in the art.

In addition to the inadequacy of some mobile networks for transferring large data files, the server itself may also experience heavy demand during peak hours. Therefore, the rate of data transfer between a mobile user device and a server may be delayed by heavy traffic experienced on the server side (i.e. the processing capacity of the server), in addition to a slow network connection at the client side (i.e. user device's connection to the internet).

Some systems use TCP/HTTP time out to solve this problem, where a client application running on the user device summits a connection request to the server, specifying a predetermined time out window. If the server fails to response within said time out window the user device terminates the connection and attempts to re-establish a new connection with the server.

### SUMMARY

The prior art methods described above attempt to ensure the network resources are distributed appropriately by enforcing a network disconnection to terminate ongoing communication instances after a time out period. However, such time out periods are simply predefined, and in many cases not adjustable nor having the ability to adapt to fluctuating conditions of the network or server. For instance, the predefined time out period does not react to a varying performance at the client side mobile connection, and nor does it take into consideration the overall demand in terms of workload at the server side.

Accordingly, the present disclosure provides an adaptive method to upload or download images or other files from/to a user terminal such as a mobile device, based on server side workload, network connection bandwidth and file size. In embodiments, applying user permissions and/or a user upload/download quota is also desirable.

According to one aspect disclosed herein there is provided a server, comprising: a network interface for forming a connection between the server and a user terminal over one or more networks, in order to perform a data transfer to upload a data file from the user terminal to the server or download a data file from the server to the user terminal; memory comprising one or more memory units, said memory storing code for enabling transfer of a data file between the user terminal and said server via said connection; processing apparatus comprising one or more processing units, said processing apparatus being arranged to run said code; wherein the code is configured so as when run on the processing apparatus to perform operations of: evaluating a size of the data file to be uploaded or downloaded; determining a measure of a current workload of the server; estimating a bandwidth of at least part of said connection; deriving a time-out window during which said transfer of the data file is allowed to be performed, wherein the deriving of the time out window is performed based on all of said data file size, server workload and bandwidth; enabling said data transfer during the time-out window, but timing out the data transfer when said time-out window expires.

In some embodiments, the time out window defines the duration running from a present time. In some other embodiments however, the time out window defines a particular time slot running from a future time, i.e. time out window may define both the start time and the end time.

In some embodiments, wherein the server is configured to perform said estimation of said bandwidth based on at least one of: a type of one of said one or more networks, and/or a historical performance of one of said one or more networks, and/or a historical performance of at least part of said connection. In some embodiments, wherein said one or more networks comprise a plurality of networks including at least an internet to which said network interface connects and a further network via which the user terminal connects to the internet, said connection being via the internet and the further network; and wherein the server is configured to perform said estimation of said bandwidth based on at least one of: a type of the further network, and/or a historical performance of the further network.

For example, the bandwidth estimation may be based on assuming a first predetermined bandwidth estimate if the type of network connecting the user terminal and the internet is of a first type, e.g. a 2G connection, and assuming a second predetermined bandwidth estimation if the network connecting the user terminal to the internet is of a second type, e.g. 3G or Wi-Fi connection. Alternatively, or in combination, the network bandwidth may be determined by monitoring past performance. In embodiments the type and/or performance may be detected by the user terminal and reported to the server by the user terminal.

In some embodiments, the user terminal comprises a mobile user terminal. For example, the mobile user terminal may be a PDA (personal digital assistant), a mobile phone, a laptop computer, a smart watch, a pair of smart glasses, or any mobile device with wireless internet connectivity. In such embodiments, said further network may be a local wireless area network, or a mobile cellular network.

Alternatively, the user terminal may be a fixed device connectable to a fixed network connection, e.g. a desktop computer connected to a PSTN socket.

In some embodiments, the data file comprises an image file. Alternatively the data file may comprise another type of data file such as video, executable program, or any other types of data file known to the person skilled in the art.

In some embodiments, said timing out comprises pausing the transfer when the time out window expires, then at a later time resuming the transfer by repeating the above operations. Alternatively, in some embodiments, said timing out may comprise terminating the transfer prematurely without permitting the resuming of the transfer.

In some embodiments, comprising at least one control server instance comprising the processing apparatus arranged to run the code perform the operations (i)-(iv), wherein the server further comprises one or more data transfer server instances for performing said data transfer. In some embodiments, wherein the one or more data transfer server instances comprise a plurality of data transfer server instances, being arranged such that a selected one of the data transfer instances performs said data transfer.

In embodiments, wherein the code is configured so as when run on the processing apparatus of the control server instance to further perform operations of: receiving a transfer request from said user terminal; and issuing a transfer token to said user terminal in response to receiving said transfer request, wherein the transfer token comprises an indication of said time-out window, and a user terminal authorisation authorising the user terminal to access the one or more data transfer server instances. In embodiments, wherein said user terminal authorization comprises a quota specifying a quantity of data allowed to be uploaded and/or downloaded in said data transfer.

By providing a control server instance and multiple data transfer instances, and operating according to a token based scheme as described, this advantageously allows the system to be scaled in a modular fashion by adding extra data transfer server instances without requiring the different server instances to be able to communicate with one another. In embodiments, the control server instance and each of the one or more data transfer server instances may function independently and be located at different geographical locations. In some examples, the data transfer server instances may be owned by different proprietors and authorisation to access each of the one or more server instances may be sought independently.

Alternatively however, it is not excluded that the functionality of the server may be fully integrated as one server unit.

In some embodiments, wherein the control server instance is arranged to determine said measure of the server workload by: periodically receiving a heartbeat from each of the one or more data transfer server instances to ascertain the workload thereat.

In some embodiments, wherein the control server instance is configured to issue said user terminal authorization on condition of authenticating an identity associated with the user terminal. For example, there may be a quota (e.g. a daily or monthly limit) dictating the upper limit of data usage a particular user is given. Exceeding such limit may time out the transfer, even before the time out window expires. Or otherwise a transfer is not allowed to start (e.g. no transfer token is issued) if the control server unit senses that the data file exceeds the predefined quota.

In some embodiments, wherein each of the one or more data transfer server instances is arranged to perform operations comprising: receiving the transfer token from said user terminal; and in response to receiving the transfer token, authorising the data transfer with the user terminal in dependence on the user terminal authorisation received in the transfer token, and selectively enabling and timing out the data transfer in accordance with the indication of the time-out window received in the transfer token. For example, the control server instance may issue the authorization on condition of authenticating an identity of a user of the user terminal, and/or on condition of authenticating an identity of an application running on the user terminal that is requesting said data transfer.

In embodiments, wherein said one of the control server instance is configured to repeat the operations (i) to (iv) in response to resubmission of the transfer token from the user terminal to the control server instance, and based thereon to reissue a new instance of the transfer token to the user terminal for resubmission to one of the one or more data transfer server instances in order to resume the data transfer.

According to another aspect disclosed herein, there is provided a user terminal for use with a server comprising at least one control server instance and one or more data transfer server instances, the user terminal comprising: a network interface for forming a connection with a network, for performing a data transfer to upload a data file to the server or download a data file from the server; memory comprising one or more memory units, said memory storing code for enabling transfer of a data file, via the network using said network interface, between said user terminal and at least one of the one or more data transfer server instances; processing apparatus comprising one or more processing units, said processing apparatus being arranged to run said code; wherein the code is configured so as when run on the processing apparatus to perform the operations of: submitting a transfer request to said control server instance, thereby causing said control server instance to issue a transfer token comprising an indication of a time out window allowed for transferring said data file, and a user terminal authorisation authorising the user terminal to access the one or more data transfer server instances; in response, receiving the transfer token from the control server instance; and submitting said transfer token to one of the one or more data transfer server instances, thereby causing said one of the data transfer server instances to authorise the data transfer in dependence on the authorization submitted in the transfer token, and to enable said data transfer during the time-out window but time out the data transfer when said time-out window expires in accordance with the indication of the time-out window submitted in the data transfer token.

In some embodiments, wherein said code is configured to cause the user terminal to send to the at least one control server instance an indication of a type of said connection between the user terminal and the network, thereby causing the control server unit to compute the time-out window at least partially based on a bandwidth estimated from the indication of the type of said connection.

In embodiments, the user terminal may be further configured to operate in a manner complementary to the server of any of the embodiments disclosed herein.

According to another aspect disclosed herein, there is provided a system comprising the server and the user terminal.

According to another aspect disclosed herein, there is provided a method of enabling the transfer of a data file to be uploaded or downloaded between a user terminal and a server via a connection over a network, the method comprising: evaluating the size of the data file to be uploaded or downloaded; determining a measure of a current workload of the server; estimating a bandwidth of at least part of said connection; deriving a time-out window during which said transfer of the data file is allowed to be performed, wherein the deriving of the time out window is performed based on all of said data file size, server workload and bandwidth; and enabling said data transfer during the time out window, but timing out the data transfer when said time out window expires.

In embodiments, wherein: the server comprises at least one control server instance which performs operations (i) to (iv) in response to a data transfer request submitted by the user terminal and issues a transfer token to the user terminal, the transfer token comprising an indication of said time-out window, and a user terminal authorisation authorising the user terminal to access the one or more data transfer server instances; the server further a number of data transfer servers, wherein any one of said number of data transfer servers is operable to receive the transfer token from the user terminal, and to authorise the data transfer in dependence on the authorization received in the transfer token, and selectively enable and time-out the data transfer in accordance with the indication of the time-out window received in the transfer token; and the method further comprises expanding the number of data transfer servers in a modular fashion

In embodiments the method may further comprise steps in accordance with any of the server, user terminal or system functionality described herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of the present disclosure and to show how embodiments may be put into effect, reference is made by way of example to the accompanying drawings in which:

FIG. 1 is a schematic illustration of a communication system,

FIG. 2 is a process flow chart according, and

FIG. 3 is another process flow chart.

### DETAILED DESCRIPTION

As discussed above, it would be desirable to provide a system and method for making an image upload or download operation dynamically adaptive to server side workload and network connection. Accordingly, the following provides a system and method for defining a time-out window, for uploading and/or downloading data files between a user device and a server, wherein the time-out window takes into account of real-time variables, including at least the server side network traffic, the quality of client side connection, and as the amount of data to be transferred.

Moreover, it would be desirable to provide a system where the server side can be readily scaled. However, because of the frequent connection and disconnection, then without putting further measures in place, the server side would require substantial communication between nodes in the cluster to handle traffic throttling. To address this, in embodiments a token is used to store information for permission control and traffic control, so that the server side can avoid communication with other nodes. According to such embodiments, the server comprises a control server instance and one or more data transfer instances (each instance being independent of the others, and/or being a separate physical server unit, i.e. a separate machine). The control server instance will issue the client with a token, which is generated dynamically based on the above factors. The user terminal can then submit the token to one of the data transfer server instances in order to use this token to request the upload or download operation. The data transfer server instance will extract the user permission and the time-out window (e.g. expiry time) for the operation from said token, and use those permissions and expiry time to control what data to transfer and how long the operation should be allowed to last. In embodiments, the token may also be submitted again by the user terminal to resume from the last break point logic and thereby avoid redundant data transfer.

In embodiments, the server is readily scalable by adding server instances in a modular fashion, without requiring the different server instances to be connected together or configured to communicate with one another.

Some exemplary embodiments will be discussed in more detail shortly, but first an overview is given of an example communication system in which embodiments of the present disclosure may be embodied.

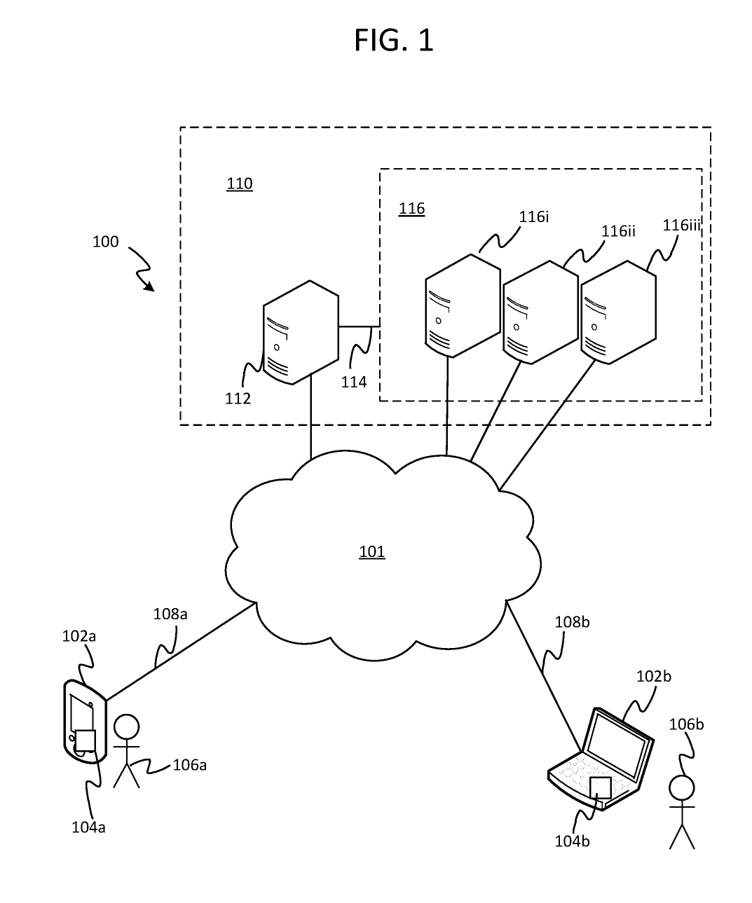

FIG. 1 schematically illustrates a communication system 100 in accordance with embodiments disclosed herein. The communication system comprises a server 110 and one or more user terminals 102a,b, each of the server 110 and the user terminals 102a,b being configured to connect to a computer network 101, and each of the user terminals 102a,b being installed with a respective instance of a communication client application 104a,b for communicating with the server 110 over the network 101. Each of the user terminals 102a,b is also used by at least one respective user 106a,b. In FIG. 1, two user terminals 102a,b and, their respective clients 104a,b, and users 106a,b are shown for illustrative purposes, but it will be appreciated that there may be different numbers of user terminals 102a,b involved in other scenarios covered by the present disclosure. For example, a single user 102a may be uploading a data file to the server 110 for later consumption, or may be downloading such a file. Or a plurality of users 102a and 102b may be engaging in a communication session such as an IM messaging session or a VoIP call via the server 110.

The network 101 is preferably a packet-based network. In embodiments it may take the form of a wide-area internetwork such as that commonly referred to as the Internet. Alternatively the network 101 may take the form of another type of network such as a company intranet. Each of one or more of the user terminals 102a,b may be connected to the main network 101 via a client side network 108a, for example, a mobile cellular network, or a wireless local area network (WLAN), or a combination of any of these.

Each of the user terminals 102a,b may take any of a variety of different forms, such as a desktop computer, laptop, tablet, smartphone, smart watch, pair of smart glasses, smart TV, set-top box, or conference room phone unit (and the different user terminals 102a,b need not necessarily take the same form as one another). Note therefore that the term “computer” as used herein does not restrict to a traditional desktop or laptop computer.

The communication clients 104a,b are each installed on computer-readable storage of their respective user terminal 102, and arranged for execution on a respective processing apparatus of the respective user terminal 102. The storage may take the form of one or more storage media (e.g. magnetic memory, electronic memory and/or optical memory) implemented in one or more memory units. The processing apparatus may take the form of one or more processing units. Each of the communication clients 104a,b is configured so as to be able to access the server 110 via the network 101 (and in embodiments via the respective local network) in order to upload and/or download one or more data files to/from the server 110. In embodiments, each of the communication clients 104a,b is also configured so as to be able to establish a communication session with one or more others of the communication clients 104a,b running on one or more of the other respective user terminals 102. The user 106 of each user terminal 102 is then able to send messages to each other of the users 106 of each other of the user terminals 102a,b participating in the session. In embodiments, the messages may include any one or more “traditional” types of message such as: IM messages, live voice (e.g. VoIP) streams (of the sending user's voice), and/or live video streams (e.g. a head-and-shoulders shot of the sending user). Alternatively or additionally, the messages may include one or more other types of message such as: still images (picture messaging), pre-recorded video clips (video messaging), pre-recorded audio clips (e.g. voice mail), a shared geographical location (e.g. as detected by a localization system such as GPS), screen sharing streams, remote slide representations, and/or electronic or virtual whiteboard streams. Some or all of the communication session may be conducted via the server 110.

The server 110 is connected to the network (e.g. Internet) 101, and is arranged to enable the uploading and/or downloading of the data files from/to the user terminal(s) 102a,b via the network 101. In embodiments, the server 110 is also arranged to provide a communication service via which the communication session is at least in part conducted. In such embodiments, the message and/or a data file from a sending user 106a is sent from the sending user terminal, e.g. 102a, to the server 110, and the server 110 is configured to forward the message and/or data file on to the recipient user terminal 102b. For instance, this arrangement may allow a first user 106a to share an image file or video file from his or her first terminal 102a, by storing in on the server 110 and thus making it available to the user terminal 102b of a second user 106b.

The system is not limited to a hosting a communication session. For example, the user 102a may wish to upload data files onto the server 110 to be stored thereat, such that it can be consumed at a later time by the sending user 102a or the receiving user 102b, e.g. the system works as a cloud storage. In such embodiments, the data file from a sending user 102a is sent from the sending user terminal, e.g. 102a, to the server 110, where it is made downloadable by one or more recipient user terminals 102a and 102b (which could be the same user terminal that uploaded it or a different user terminal).

Note also, in yet further embodiments, the system need not necessarily comprise a dedicated communication client 104 installed on each user terminal 102. For instance, the user terminals could instead be installed with a general purpose client such as a web browser operable to access a web-based version of the communication client application (“web client”) hosted on the server 110. In such cases the described functionality may be achieved by the web-client running through the browser, rather than the locally installed dedicated communication client (i.e. client installed locally on an individual user terminal 102a). Or more generally, the functionality disclosed herein can be implemented by any combination of a local client application 104 (on each user terminal 102a) and/or server hosted functionality (e.g. a web client). For conciseness the various options in this respect will not be repeated each time the functionality below is described, but it will be understood that these options apply throughout.

In the illustrated example, the server 110 comprises at least one control server unit 112 and one or more instances of data transfer server 116. The different server units may also be described herein as server instances. They are discreet modules which may be configured to operate independently of one another, and/or which take the form of physically separate server units (i.e. different machines). In embodiments some or all of the different server units may be physically located at different geographical sites.

The control server unit 112 administers the transfer between the user terminals 102a,b and the data transfer server instances 116. It is responsible for granting access and authorising transfer, as well as determining a suitable time out window for data transfer based on at least some measured parameters. In some embodiments there may be more than one instance of the control server unit 112, e.g. with each duplicating the same functionality such that the user terminal 102 can contact any control server instance to initiate a transfer.

The data transfer server instances 116 communicate with the user terminals 102a,b for uploading and/or downloading data files. There may be only one instance of data transfer server instances 116, or more preferably there may be a plurality of data transfer server instances 116i-116iii wherein each is operable to communicate with the user terminals 102a,b such that a user terminal 102 can upload or download a file to/from any selected one of multiple data transfer server instances 116. This enables traffic throttling among the data transfer server instances 116i-iii.

The control server unit 112 and data transfer server instances 116 may be combined as a single server 110, or they can be separate and can even be physically located at different geographical locations. For example, the control server unit 112 can be positioned in a geographical region distant from the user terminal 102 and/or one or more of the data transfer server instances 116, or vice versa. Each of the data transfer server instances 116i-iii communicates with the control server unit 112 via a server link 114 to provide a heartbeat to the control server unit 112. Said heartbeat confirms its presence, and additional conveys information such as network work load, maintenance schedules and traffic statistics, etc. The server link 114 may be implemented over the same communication network 101 used to perform the data transfer with the user terminal(s) 102, e.g. the Internet. Alternatively, it is not excluded that the server link could be a dedicated link, but this is less preferred as it hinders the scalability of the system.

Preferably, the control server unit 112 is able to administer the data transfer between the user terminal 102 and the data transfer server instances without needing to communicate with the data transfer server instances 116. Instead is arranged to use a system of tokens, whereby it issues a token to the user terminal 102 which the user terminal can then submit to one of the data transfer servers 116 to initiate the upload or download. This way the system can be readily scaled by adding data transfer server instances in a modular fashion.

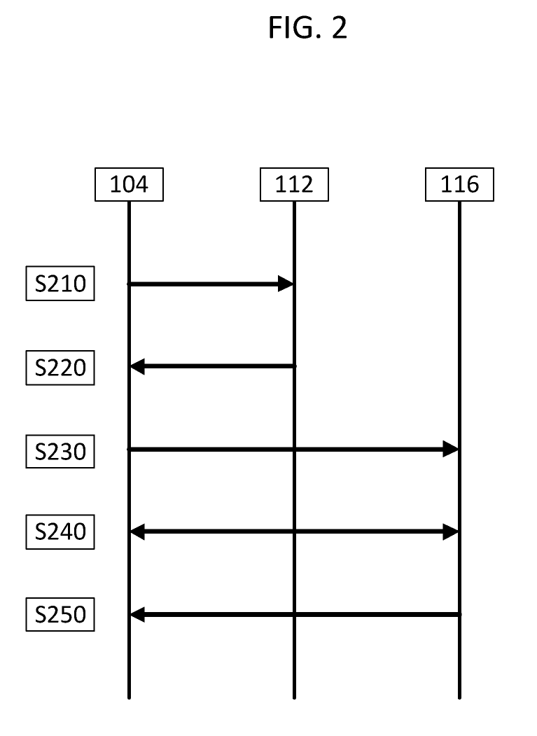

A method of operating the system 100 is illustrated in FIG. 2. In step S210, the user 106a requests a data file transfer (uploading and/or downloading) via a user input at the client application 104a of the user terminal 102a, causing the user terminal 102a to submit a transfer request to the control server unit 112, through the Internet 101 via client-side network 108a. The transfer request comprises information relevant to the data transfer, such as quantity (e.g. size and number) and type (e.g. video or image) of the data file, as well as network information. The network information conveys information of the client-side network 108a to the control server unit 112 so that its bandwidth can be approximated. The network information may consist of an indication of the type of network 108a, e.g. 2G/3G/LTE/Wi-Fi, thereby allowing the control server unit 112 to estimate the bandwidth based on the network type, by assuming a certain predetermined bandwidth for a given network type. Alternatively, the network information may comprise data collected from historical performance. In another embodiment, the user device terminal 102a may conduct a speed check and convey the real-time performance of the client-side network 108a to the control server unit 112 as the network information.

Upon receiving the transfer request from the user terminal 102a, the control server unit 112 then derives a time-out window for the data file transfer, based on parameters such as the (a) quality of network 108a, (b) size of data file from the transfer request, and (c) network workload. The server workload is a measure of the current processing burden being placed on the server 110. In embodiments, the control server unit 112 may be configured to determine the network workload from the heartbeat of each of the data transfer server instances 116i-iii. Said time widow may be a time-out period which defines the transfer duration running from the time of processing the request from the user terminal 102a, or alternatively the time out window may be in the form of a scheduled time slot where the start time is also specified.

The time-out window is calculated by first working out an estimated load time from parameters (a) and (b), e.g. by dividing the size of the data file by the estimated bandwidth of the network 108a. For example, the load time for uploading a 800 MB video file is estimated to be around 14 seconds using an LTE connection with an upload rate at 58 Mbit/s (800 MB/58 MBŝ−1=14 s). Subsequently the load time is multiplied by a server performance factor to define the time out window. The server performance factor is based upon the workload of each of the data transfer server instances 116i-iii, wherein a data transfer server instance 116 experiencing high network traffic is awarded with a lower performance factor, so that the transfer time allocated for this busy server instance may be reduced. Accordingly, a quieter data transfer server instance 116 server with less network traffic will be rated with a higher performance factor, so as to permit a longer transfer time before the transfer is cut off (timed out). In some embodiments, the server performance factor ranges from 0.8 (server units with the heaviest network traffic) to 1.2 (server units 116 with the least network traffic). Taking the above example, the time out window for the video file would be 11.2 s for the busiest data transfer server instance, and said time out window would be lengthened to 16.8 s for a quiet data transfer server instance. That is, data transfer between the user terminal 102a and the data transfer server instance 116 ceases or pauses after the time out window expires, e.g. the duration of the time out window has fully elapsed, and may resume once a new transfer cycle starts. In some embodiments, the server performance factor ranges from 0.5 to 1.5. In some other embodiments, the server performance factor can be reduced to 0 to prevent data transfer to be initiated for an already busy server instances.

In some embodiments, the server performance factor may alternatively or additionally be based on other factors such as maintenance schedules and traffic statistics. This enables the control server unit 112 to predict periodic changes in the future, e.g. peak time traffic, so as to predictively adjust the time out window for any impending data transfers. For instance, a scheduled time slot for data transfer may be allocated during periods with lower server traffic, e.g. low priority tasks such as data backup and update installations may be scheduled during the middle of the night when traffic to and from data transfer server instances 116 is at its quietest. In some further embodiments, the time out window may be scheduled for time slots that are specific to each of the available data transfer server instances 116i-iii. E.g. the data transfer to each of the instances may not start simultaneously, where data transfer to some busier instances is deferred to a quieter time.

In some embodiments, the time-out window for each of the available data transfer server instances 116i-iii serves as a distribution mechanism for throttling traffic among said instances. For example, the control server unit 112 may adjust the server performance factor for each of the data transfer server instances 116i-iii according to their network traffic relative to each other, such that the busiest data transfer server instances 116 are given the shortest time out window in order to reduce their work load, and vice versa. This permits a more evenly distributed data transfer among the available data transfer server instances 116i-iii.

Referring back to FIG. 2, once a time-out window for each of the data transfer server instances is determined, the control server unit 112 issues a transfer token to the user device 102a (Step S220). The transfer token is responsible for providing permission control and traffic control information interpretable at each of the data transfer server instances 116i-iii. It comprises the determined time-out window for conducting the data transfer, as well as authorisation for said transfer to commence. Said authorisation in the transfer token may comprises a user quota that is specific to the user 106a and defines the quantity of data a user is permitted to send or receive. In some embodiments the data transfer times-out once the defined quantity or limit is reached, even though the time out window is not yet lapsed. In some cases the control server unit 112 checks if the size of data file to be transferred is larger than the allowable user quota, and if so the control server unit 112 are programmed to not issue a transfer token at all. In this case the control server unit 112 informs the user terminal 102a of said event and urges the user 106a to either resubmit a transfer request at a later time, or to purchase credit to increase his/her allowable user quota. The transfer token may, in some cases, additionally contain one or more machine readable data transfer instructions for consumption at the user terminal 102a and/or the data transfer server instances 116, in order to execute said data transfer. In embodiments, a different quote may be specified in the token for uploads and downloads.

In embodiments, the control server unit 112 is configured only to issue the token on condition of authenticating that the client application 104a requesting the transfer is authorized (i.e. is verified as an application published by a particular trusted and/or approved source or sources). And/or, the control server unit 112 is configured only to issue the token on condition of authenticating that the user 106a of the user terminal 102a is authenticated (i.e. the user's identity is verified as being that of a known user who is allowed to use the service).

Upon receiving the transfer token from the control server unit 112, the user terminal 102a relays said token directly to a designated one of the data transfer server instances 116i-iii (Step S230). For example, the client 104a on the user terminal 102a may submit the token to the server instance 116 that is nearest by geographically or nearest in terms of network hops, or the client 104a may select one of the server instances 116 randomly, or it may submit the token to one of the data transfer instances specified by the control server 112 (e.g. that currently having the lowest workload). Whichever data transfer server 1116 is chosen, the token invokes said data transfer server instance 116i-iii to authorise the user terminal to commence data transfer within the given time-out window (assuming the data transfer server instance 116 authenticates in the token is verified as genuine). Advantageously, frequent communication between the control server unit 112 and the data transfer server instances 116i-iii as would be required using the prior art techniques is no longer needed. The control server unit 112 only require knowledge of network traffic at the data transfer server instances 116 via the periodic heartbeat updates, but no longer need to directly communicate with said data transfer server instances 116 to control data transfer operations.

Data transfer then commences (Step S240) between the user terminal 102a and the data transfer server instance 116. The data transfer operation may be an uploading operation where the user terminal 102a transfers data to the data transfer server instance 116, or it may be a downloading operation where the user terminal 102b acquires data from the data transfer server instance 116. The data being transferred may be an image file, a video file, a program file or any other type of data file known to the person skilled in the art. In any case, the data transfer operation may stop either when the whole of the data file is successfully transferred to its destination prior to expiration of the time out window, or when the amount of data transferred exceeds a predefined user quota, or at the instance when the time-out window expires (Step S250). If the time-out window expires before the transfer of a given file is completed, then the transfer (upload or download) of that file is truncated mid transfer.

In the latter case the data file transfer may be resumed by repeating the process, i.e. in other words, the transfer token issued previously for the initial transfer expires upon the lapse of said time-out window. The data transfer server instances 116 do not allow recycling of an issued transfer token for subsequent transfers because the authorisation and time schedule may no longer be valid at a later time.

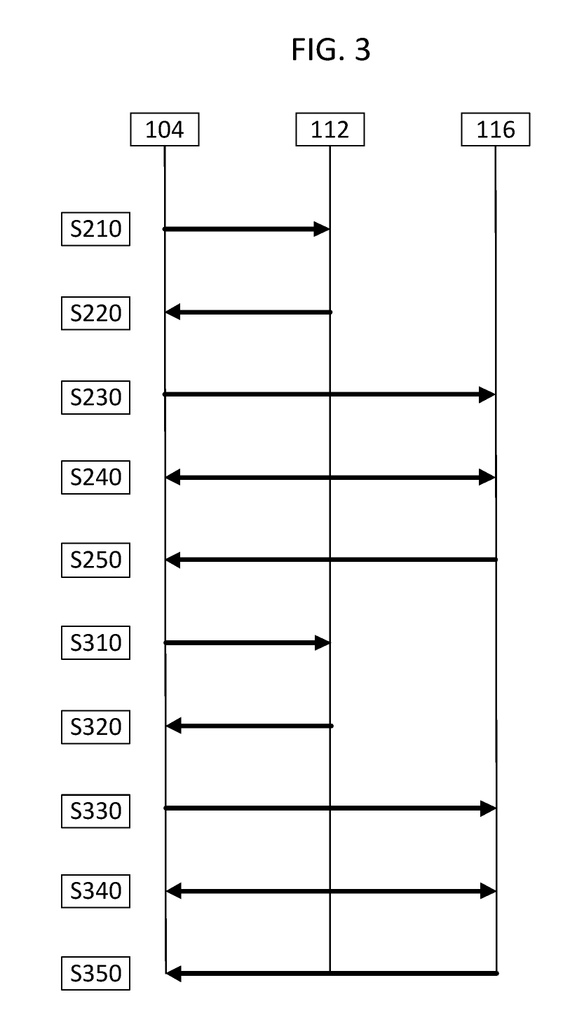

Refer now to FIG. 3, which shows the process flow for resuming a paused transfer when said the data transfer is cut off (timed out) before it has completed. It is preferably required for the user device 102a to resubmit the transfer request for the remaining data, such that that the control server unit 112 may better utilise the resources at data transfer server instances 116 that are available for resuming the transfer. The steps S310-S340 as shown in FIG. 3 are recurrences of previously described steps S210-S240. In S310, the user terminal 102a submits a new transfer request detailing the size for the remaining part of the data file to be transferred. In response, the control server unit 112 determines a new time out window based on size of remaining part of the data file, as well as the present network traffic at each of the data transfer server instances 116i-iii and the information of connecting network 108a. In some cases, said information about the client-side connecting network 108a may comprise quantitative measures of network quality based on the previous data transfer instances, e.g. the actual uploading/downloading rate achieved before the transfer was stopped.

Thereafter the control server unit 112 issues a new transfer token (Step S320) to the user terminal 102a for enabling the transfer of the remaining data files. The new transfer token is then sent, from the user terminal 102a to a designated one of the data transfer server instances 116i-iii (Step S330), which need not to be the same as the data transfer server instance 116i-iii previously used. This provides flexibility in allocating data transfer between the available data transfer server instances 116, according to the reported traffic at the presence time.

Upon receiving the new transfer token, the targeted data transfer server instance 116 authorises said transfer of the remaining part of the data file within the specified time-out window (Step S340) and file transfer operation commences. As with the data flow in FIG. 2, the data transfer process stops once all of the data files are fully transferred, or upon exceeding said predetermined user quota, or upon the expiry of time out window, even if the data file transfer is not fully completed (Step S350). The cycle is repeated until the data file is fully transferred between the user device 102a and the data transfer server instances 116.

Thus as has been exemplified above, the present disclosure provides a method of uploading and/or downloading image data between mobile device and image host server, comprising:

a) estimating the size of the image to be uploaded or downloaded;

b) determining server work load;

c) estimating connection bandwidth between said mobile device and said image host server;

d) calculating how long an upload or download operation is allowed to execute, based on result of step a), b) and c);

e) encoding user permission, user available quota, and operation expire time (based on result of step d) into a token;

f) performing the upload or download operation using the token generated in step e, and recording how many bytes of the image is uploaded or downloaded;

g) checking if both permission granted in token and quota is sufficient to access the data. If not, reject client's request, and fail the whole operation;

h) checking if eclipsed time of the upload or download operation is greater than the expire time of token or not;

i) terminating the upload or download operation if all data is uploaded/downloaded, or if checking result of step h) is Yes; and

j) repeating this method until all data is uploaded or downloaded.

In an example use case, the above-described user terminal 102a is that of a first user 106a is participating in an instant messaging (IM) session with another (second) user 106b. In this use case, the first user 106a would like to share a data file with the second user 106b, and so the sending user terminal 102a initiates a transfer request for a transfer token from the control server unit 112, to enable the uploading of said data file to one of the data transfer server instance 116, according to Steps S210-S250 (and/or S310-S350 for resuming a paused transfer). At the other end, the receiving user terminal 102b also initiates the same transfer request procedure at the control server unit 112 according the Step S210-S250 (and/or S310-S350 for resuming a paused transfer), in order to download the data file from the data transfer server instances. Therefore, the same procedure as depicted in Steps S210-S250 and S310-S350 applies to both uploading and downloading a data file to/from the data transfer server instances 116.

It will be appreciated that the above embodiments have been described only by way of example. Other variants and use cases may become apparent to a person skilled in the art once given the disclosure herein. The scope of the disclosure is not limited by the described embodiments but only by the accompanying claims.

1. A server, comprising:
a network interface for forming a connection between the server and a user terminal over one or more networks, in order to perform a data transfer to upload a data file from the user terminal to the server or download a data file from the server to the user terminal;
memory comprising one or more memory units, said memory storing code for enabling transfer of a data file between the user terminal and said server via said connection;
processing apparatus comprising one or more processing units, said processing apparatus being arranged to run said code; wherein the code is configured so as when run on the processing apparatus to perform operations of:
evaluating a size of the data file to be uploaded or downloaded;
determining a measure of a current workload of the server;
estimating a bandwidth of at least part of said connection;
deriving a time-out window during which said transfer of the data file is allowed to be performed, wherein the deriving of the time out window is performed based on all of said data file size, server workload and bandwidth;
enabling said data transfer during the time-out window, but timing out the data transfer when said time-out window expires.

2. The server of claim 1, wherein the time out window defines the duration running from a present time.

3. The server of claim 1, wherein the server is configured to perform said estimation of said bandwidth based on at least one of: a type of one of said one or more networks, and/or a historical performance of one of said one or more networks, and/or a historical performance of at least part of said connection.

4. The server of claim 3, wherein said one or more networks comprise a plurality of networks including at least an internet to which said network interface connects and a further network via which the user terminal connects to the internet, said connection being via the internet and the further network; and
wherein the server is configured to perform said estimation of said bandwidth based on at least one of: a type of the further network, and/or a historical performance of the further network.

5. The server of claim 1, wherein the user terminal comprises a mobile user terminal.

6. The server of claim 1, wherein the data file comprises an image file.

7. The server of claim 1, wherein said timing out comprises pausing the transfer when the time-out window expires, then at a later time resuming the transfer by repeating operations (i)-(v).

8. The server of claim 1, comprising at least one control server instance comprising the processing apparatus arranged to run the code perform the operations (i)-(iv), wherein the server further comprises one or more data transfer server instances for performing said data transfer.

9. The server of claim 8, wherein the one or more data transfer server instances comprise a plurality of data transfer server instances, being arranged such that a selected one of the data transfer instances performs said data transfer.

10. The server of claim 8, wherein the control server instance is arranged to determine said measure of the server workload by: periodically receiving a heartbeat from each of the one or more data transfer server instances to ascertain the workload thereat.

11. The server of claim 9, wherein the code is configured so as when run on the processing apparatus of the control server instance to further perform operations of:
receiving a transfer request from said user terminal; and
issuing a transfer token to said user terminal in response to receiving said
transfer request, wherein the transfer token comprises an indication of said time-out window, and a user terminal authorisation authorising the user terminal to access the one or more data transfer server instances.

12. The server of claim 11, wherein said user terminal authorization comprises a quota specifying a quantity of data allowed to be uploaded and/or downloaded in said data transfer.

13. The server of claim 11, wherein the control server instance is configured to issue said user terminal authorization on condition of authenticating an identity associated with the user terminal.

14. The server of claim 11, wherein each of the one or more data transfer server instances is arranged to perform operations comprising:
receiving the transfer token from said user terminal; and
in response to receiving the transfer token, authorising the data transfer with the user terminal in dependence on the user terminal authorisation received in the transfer token, and selectively enabling and timing out the data transfer in accordance with the indication of the time-out window received in the transfer token.

15. The server of claim 11, wherein said one of the control server instance is configured to repeat the operations (i) to (iv) in response to resubmission of the transfer token from the user terminal to the control server instance, and based thereon to reissue a new instance of the transfer token to the user terminal for resubmission to one of the one or more data transfer server instances in order to resume the data transfer.

16. A user terminal for use with a server comprising at least one control server instance and one or more data transfer server instances, the user terminal comprising:
a network interface for forming a connection with a network, for performing a data transfer to upload a data file to the server or download a data file from the server;
memory comprising one or more memory units, said memory storing code for enabling transfer of a data file, via the network using said network interface, between said user terminal and at least one of the one or more data transfer server instances;
processing apparatus comprising one or more processing units, said processing apparatus being arranged to run said code; wherein the code is configured so as when run on the processing apparatus to perform the operations of:
submitting a transfer request to said control server instance, thereby causing said control server instance to issue a transfer token comprising an indication of a time out window allowed for transferring said data file, and a user terminal authorisation authorising the user terminal to access the one or more data transfer server instances;
in response, receiving the transfer token from the control server instance; and
submitting said transfer token to one of the one or more data transfer server instances, thereby causing said one of the data transfer server instances to authorise the data transfer in dependence on the authorization submitted in the transfer token, and to enable said data transfer during the time-out window but time out the data transfer when said time-out window expires in accordance with the indication of the time-out window submitted in the data transfer token.

17. The user terminal of claim 16, wherein said code is configured to cause the user terminal to send to the at least one control server instance an indication of a type of said connection between the user terminal and the network, thereby causing the control server unit to compute the time-out window at least partially based on a bandwidth estimated from the indication of the type of said connection.

18. The user terminal of claim 16, wherein the type of said connection comprises one of a cellular connection or a WiFi connection.

19. A method of enabling the transfer of a data file to be uploaded or downloaded between a user terminal and a server via a connection over a network, the method comprising:
evaluating the size of the data file to be uploaded or downloaded;
determining a measure of a current workload of the server;
estimating a bandwidth of at least part of said connection;
deriving a time-out window during which said transfer of the data file is allowed to be performed, wherein the deriving of the time out window is performed based on all of said data file size, server workload and bandwidth; and
enabling said data transfer during the time out window, but timing out the data transfer when said time out window expires.

20. The method of claim 19, wherein:
the server comprises at least one control server instance which performs operations (i) to (iv) in response to a data transfer request submitted by the user terminal and issues a transfer token to the user terminal, the transfer token comprising an indication of said time-out window, and a user terminal authorisation authorising the user terminal to access the one or more data transfer server instances;
the server further a number of data transfer servers, wherein any one of said number of data transfer servers is operable to receive the transfer token from the user terminal, and to authorise the data transfer in dependence on the authorization received in the transfer token, and selectively enable and time-out the data transfer in accordance with the indication of the time-out window received in the transfer token; and
the method further comprises expanding the number of data transfer servers in a modular fashion.
